(19) United States
(12) Patent Application Publication
(10) Pub. No.: US 2015/0145941 A1
(43) Pub. Date: May 28, 2015

(54) THERMAL TRANSFER PRINTER

(71) Applicant: Shandong New Beiyang Information Technology CO., Ltd., Shandong (CN)

(72) Inventors: Ming Gao, Shandong (CN); Zhihua Wen, Shandong (CN); Tianxin Jiang, Shandong (CN); Shuxun Dong, Shandong (CN)

(21) Appl. No.: 14/405,705

(22) PCT Filed: May 17, 2013
(86) PCT No.: PCT/CN2013/075832

§ 371 Date: Dec. 4, 2014

(30) Foreign Application Priority Data
Jun. 6, 2012 (CN) 201210184691.6

(51) Int. Cl. B41J 2/325

(52) U.S. Cl. CPC B41J 2/325
USPC 347/217

(57) ABSTRACT

A thermal transfer printer comprises a frame, a printing mechanism, and a ribbon mechanism, wherein the frame comprises a base, and a ribbon bracket and an upper housing pivoted with the base through a respective pivot shaft thereof, wherein the frame further includes a linkage mechanism used to open the ribbon bracket in linkage when the upper housing is opened relative to the base, and a driven member fixedly connected with the ribbon bracket, and a rotation axis of the driven member is coaxial with a pivot shaft of the ribbon bracket; a rotational direction of the driving member is the same with a rotational direction of the driven member; an operating space for installing the ribbon is formed between the upper housing and the ribbon bracket when the upper housing is open.

The application claims the priority of Chinese patent application No. 201210184691.6, entitled “Thermal Transfer Printer” filed with the State Intellectual Property Office of the People's Republic of China on Jun. 6, 2012, the entire contents of which are incorporated herein by reference.

### TECHNICAL FIELD OF THE INVENTION

The disclosure relates to a thermal transfer printer.

### BACKGROUND OF THE INVENTION

FIG. 1 shows a frame structure of a common thermal transfer printer including a lower housing 20′, an upper housing 30′, a ribbon bracket 40′ and a locking mechanism. Wherein the upper housing 30′ is pivoted with the lower housing 20′ through a pivot shaft 31′ and may be opened or closed relative to the lower housing 20′; the ribbon bracket 40′ is pivoted with the lower housing 20′ through a pivot shaft 401′ and may be opened or closed relative to the lower housing 20′, wherein, along the opening and closing direction, the ribbon bracket 40′ is located between the upper housing 30′ and the lower housing 20′; the locking mechanism includes a first locking mechanism 51′ and a second locking mechanism 52′, wherein the first locking mechanism 51′ is configured to fix the ribbon bracket 40′ on a locking position being dosed relative to the lower housing 20′; the second locking mechanism 52′ is configured to fix the upper housing 30′ to a locking position being closed relative to the lower housing 20′.

The printer further includes a printing mechanism, a ribbon mechanism and a paper roll supporting mechanism 13′. The printing mechanism includes a printing head 12′ and a printing platen 11′, wherein the printing platen 11′ is provided on the lower housing 20′, and the printing head 12′ is provided on the ribbon bracket 40′. When the ribbon bracket 40′ is opened relative to the lower housing 20′. the printing platen 11′ and the printing head 12′ are separated; When the ribbon bracket 40′ is closed relative to the lower housing 20′, the printing roller 11′ is tangent to the printing head 12′; the ribbon mechanism is provided on the ribbon bracket 40′ and includes a supply shaft 15′ and a take-up shaft 14′. The paper roll supporting mechanism 13′ is provided on the lower housing 20′ for supporting a paper roll.

When installing a ribbon or printing paper, the second locking mechanism 52′ needs to be opened first so that the upper housing 30′ is opened relative to the lower housing 20′ to expose the paper roll supporting mechanism 13′. Subsequently, the first locking mechanism 51′ is opened so that the ribbon bracket 40′ is opened relative to the lower housing 20′, and the printing platen 11′ and the printing head 12′ are separated at the moment. Wherein, when installing the ribbon, an unused ribbon roll is installed on the supply shaft 15′ first. Subsequently, the unused ribbon is pulled out from the supply shaft 15′, passes between the printing head 12′ and the printing platen 11′ and then is rewound on the take-up shaft 14′. The installation of the ribbon is completed at the moment. When installing the printing paper, a paper roll is placed on the paper roll supporting mechanism 13′ first. Subsequently, the front end of the printing paper is pulled out from the paper roll, and passes between the printing head 12′ and the printing platen 11′. At the moment, the installation of the printing paper is completed. After the installation of the ribbon or printing paper, the ribbon bracket 40′ is closed first and is fixed to the locking position being closed relative to the lower housing 20′ by the first locking mechanism 51′. Subsequently, the upper housing 30′ is dosed and is fixed to the locking position being dosed relative to the lower housing 20′ through the second locking mechanism 52′ to wait for executing a printing operation.

The problem of the printer is that, regardless of installing the printing paper or ribbon, the second locking mechanism needs to be opened first, and the upper housing is opened relative to the ribbon bracket, then the first locking mechanism is opened, and the ribbon bracket is then opened relative to the lower housing. After the installation of printing paper or ribbon is completed, the ribbon bracket further needs to be closed relative to the lower housing first, and the ribbon bracket is fixed relative to the position of the lower housing through the first locking mechanism, and then the upper housing is closed relative to the ribbon bracket, and the upper housing is fixed relative to the position of the ribbon bracket through the second locking mechanism. A plurality of operations is required, thus causing problems of complicated operating steps and inconvenient maintenance.

### SUMMARY OF THE INVENTION

The purpose of the disclosure is to provide a thermal transfer printer which is simple in operation and convenient in maintenance.

In view of this, the disclosure provides a thermal transfer printer includes a frame, a printing mechanism, and a ribbon mechanism, wherein the frame includes a base, and a ribbon bracket and an upper housing pivoted with the base through a respective pivot shaft thereof, wherein the frame further includes a linkage mechanism used to open the ribbon bracket in linkage when the upper housing is opened relative to the base, wherein the linkage mechanism includes a driving member fixedly connected with the upper housing and a driven member fixedly connected with the ribbon bracket, wherein a rotation axis of the driving member is coaxial with a pivot shaft of the upper housing, and a rotation axis of the driven member is coaxial with a pivot shaft of the ribbon bracket; the driving member and the driven member are engaged directly or indirectly; a rotational direction of the driving member is the same with a rotational direction of the driven member; an operating space for installing the ribbon is formed between the upper housing and the ribbon bracket when the upper housing is open.

Further, at least one transition member for transiting transmission is provided between the driving member and the driven member; the transition member is a gear; the driving member is a second gear; the driven member is a third gear.

Further, a rotation angle of the ribbon bracket being open is less than a rotation angle of the upper housing being open.

Further, the number of the transition member provided between the driving member and the driven member is one; the pivot shaft of the upper housing and the pivot shaft of the ribbon bracket are located at the same side of a rotation shaft of the transition member along a first direction; in a second direction vertical to the first direction, the pivot shaft of the ribbon bracket, the rotation shaft of the transition member and the pivot shaft of the upper housing are provided at intervals in turn, wherein, in the first direction, the rotation shaft of the transition member is closer to a bottom surface of the base than the pivot shaft of the upper housing.

Further, the driven member and the driving member are sector gears.

Further, the driving gear is a gear; the driven gear is an annular gear directly engaged with the driving gear.

Further, an external sleeve as the pivot shaft of the ribbon bracket is provided on the base; an internal sleeve is eccentrically provided inside the external sleeve; the ribbon bracket is provided with a core hole sleeved on the external sleeve; the pivot shaft of the upper housing is supported in the internal sleeve.

Further, the thermal transfer printer further includes a locking mechanism for locking the upper housing when the upper housing is closed relative to the base.

Further, the locking mechanism includes: a rotation shaft, provided on one of the upper housing and the base; a locking hook, fixedly connected to the rotation shaft; a wrench, fixedly connected with an end of the rotation shaft for driving the rotation shaft to rotate; and a locking shaft, located on another of the upper housing and the base; when the upper housing is closed relative to the base, the locking hook is matched with the locking shaft in a clamping manner.

Further, the maximum rotation angle of the upper housing being open is greater than 90°.

Further, the printing mechanism includes a printing head and a printing platen, wherein the printing head is provided on the ribbon bracket; the printing platen is provided on the base; the ribbon mechanism includes a supply shaft and a take-up shaft; the supply shaft and the take-up shaft are provided on the ribbon bracket.

The thermal transfer printer according to the disclosure includes the linkage mechanism used to open the ribbon bracket in linkage when the upper housing is opened relative to the base. The linkage mechanism includes the driving member fixedly connected with the upper housing and the driven member fixedly connected to the ribbon bracket. The driving member and the driven member are engaged directly or indirectly. When the upper housing is driven to open or close relative to the base, the ribbon bracket may be rotated and opened or closed with the upper housing relative to the base, and the rotation angle of the ribbon bracket is less than the rotation angle of the upper housing, so that an operating space for installing the ribbon is formed between the ribbon bracket and the upper housing so as to install the ribbon conveniently.

With regard to the thermal transfer printer provided by the disclosure, the operator could open the ribbon bracket in linkage and complete replacing the ribbon or paper roll through opening the upper housing once merely. Therefore, the thermal transfer printer provided by the disclosure is simple in operation and convenient in maintenance.

Besides the above-mentioned purposes, features and advantages, other purposes, other features and advantages of the disclosure will be further described in details with reference to the accompanying drawings.

### BRIEF DESCRIPTION OF THE DRAWINGS

The accompanying drawings, which constitute one part of the specification for further understanding the disclosure, show preferred embodiments of the disclosure and are used for describing the principle of the disclosure with the specification. In the drawings:

FIG. 1 is a structural view of an existed thermal transfer printer when an upper housing and a ribbon bracket are opened;

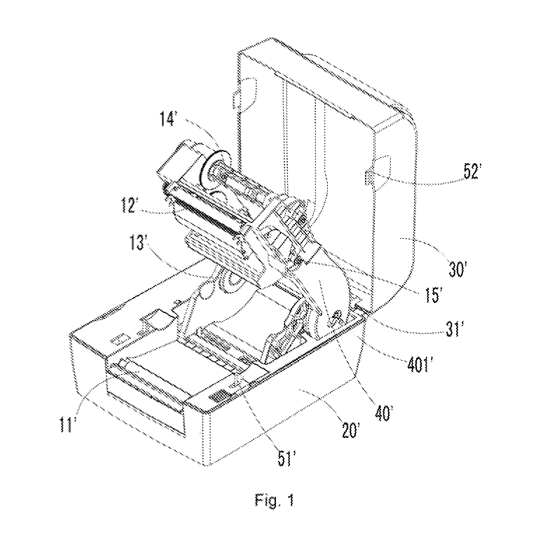

FIG. 2 is a sectional view of a structure of a thermal transfer printer according to the first embodiment of the disclosure;

FIG. 3 is an axonometric drawing of a structure of a thermal transfer printer when an upper housing is opened according to the first embodiment of the disclosure;

FIG. 4 is a side view of a structure of a thermal transfer printer when an upper housing is opened according to the first embodiment of the disclosure;

FIG. 5 is a side view of a structure of a thermal transfer printer when an upper housing is opened according to the second embodiment of the disclosure;

FIG. 6 is a structural view of a thermal transfer printer provided with a sleeve base according to the second embodiment of the disclosure;

FIG. 7 is a structural view illustrating connection between a driving member of a linkage mechanism and an upper housing of a thermal transfer printer according to the second embodiment of the disclosure; and

FIG. 8 is structural view illustrating connection between a driven member of a linkage mechanism and a ribbon bracket of a thermal transfer printer according to the second embodiment of the disclosure.

### REFERENCE NUMERALS

1. paper roll supporting mechanism
2. printing mechanism
3. ribbon mechanism
100. base
200. upper housing
300. ribbon bracket
400. linkage mechanism
500. locking mechanism
510. rotation shaft
520. locking hook
521. wrench
530. locking shaft
531. printing head
22. printing platen
31. supply shaft
32. take-up shaft
41. first gear
42. second gear
43. third gear
44. first gear shaft
421. second gear shaft
431. third gear shaft
42′. fourth gear
43′. annular gear
41′. external sleeve
411′. internal sleeve
421′. rotation shaft
422′. external teeth part
431′. core hole
432′. internal teeth part

### DETAILED DESCRIPTION OF THE INVENTION

The embodiments of the disclosure will be described in details below with reference to the accompanying drawings, but the disclosure may be implemented in various different ways defined and covered by the claims.

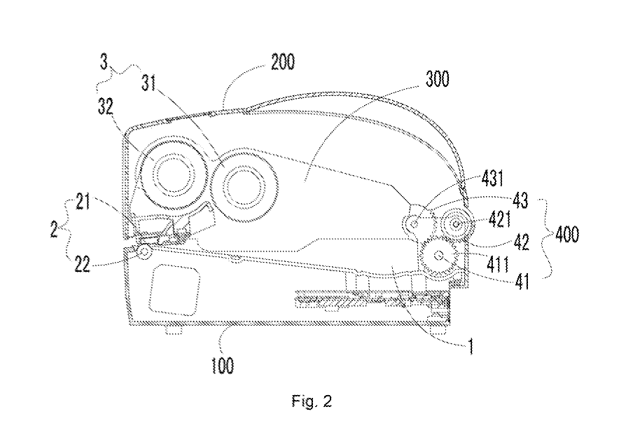

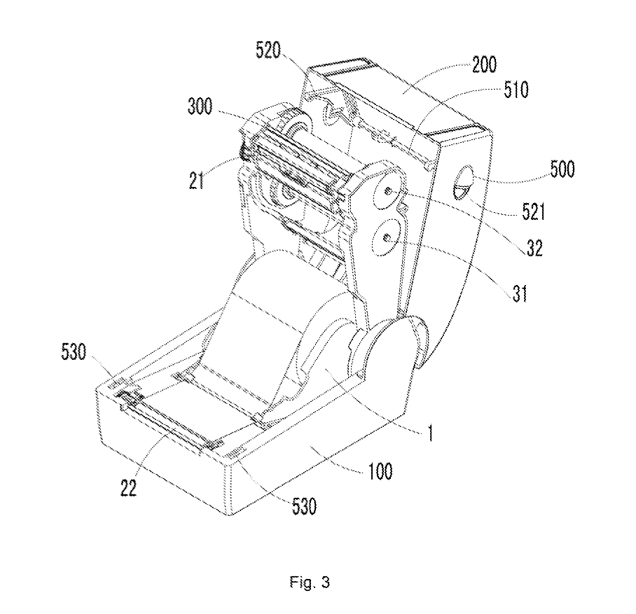

FIG. 2 is a sectional view of a structure of a thermal transfer printer according to the first embodiment of the disclosure. FIG. 3 is an axonometric drawing of a structure of a thermal transfer printer when an upper housing is opened according to the first embodiment of the disclosure. As shown in FIG. 2 and FIG. 3, the thermal transfer printer includes a frame, a paper roll supporting mechanism 1, a printing mechanism 2 and a ribbon mechanism 3.

Wherein the frame includes a base 100, an upper housing 200, a ribbon bracket 300. and a linkage mechanism 400 used to open the ribbon bracket 300 while opening the upper housing 200, wherein, the upper housing 200 and the ribbon bracket 300 are pivoted with the base 100, and the upper housing 200 and the ribbon bracket 300 are connected in transmission through the linkage mechanism 400 so that the ribbon bracket 300 may rotate to be opened or closed with the upper housing 200 relative to the base 100. Along the opening and closing direction of the upper housing 200, the ribbon bracket 300 is located between the base 100 and the upper housing 200. During the process that the ribbon bracket 300 rotates to be opened with the upper housing 200 relative to the rotation of the base 100, the rotation angle of the ribbon bracket 300 is less than that of the upper housing 200.

Preferably, the frame further includes a locking mechanism 500 for fixing the upper housing 200 on a locking position being closed relative to the base 100. Preferably, the locking mechanism 500 includes a rotation shaft 510, a locking hook 520, a wrench 521 and a locking shaft 530, wherein the locking hook 520 is fixedly connected with the rotation shaft 510, hinged to one of the base 100 and the upper housing 200 through the rotation shaft 510, and may rotate around the rotation shaft 510. The locking shaft 530 is provided on the other one of the base 100 and the upper housing 200. When the upper housing 200 is closed relative to the base 100, the locking shaft 530 may be matched with the locking hook 520 in a clamping manner to fix the upper housing 200 on the locking position being dosed relative to the base 100. The wrench 521 is fixedly connected with one end of the rotation shaft 510 or the locking hook 520, and located outside the base 100 or the upper housing 200 of the printer. An operator may press or rotate the wrench 521 to drive the rotation shaft 510 to rotate so that the locking hook 520 and the locking shaft 530 are separated.

Specifically, the locking mechanism 500 in the present embodiment includes two locking hooks 520 located on two ends of the rotation shaft 510, hinged to the side wall of the upper housing 200 through the rotation shaft 510 respectively, and capable of rotating with the rotation of the rotation shaft 510. The locking shaft 530 is provided on two side walls of the base 100 on a position corresponding to the two locking hooks 520. The wrench 521 is fixedly connected with the locking hooks 520 and located outside the upper housing 200. When dosed relative to the base 100, the upper housing 200 is matched with the locking shaft 530 in a clamping manner through the locking hooks 520 so that the upper housing 200 is fixed to the locking position being closed relative to the base 100. When the operator presses or rotates the wrench 521, the wrench 521 drives the locking hooks 520 to rotate around the rotation shaft 510 so that the locking hooks 520 and the locking shaft 530 are separated so as to open the upper housing 200 relative to the base 100.

In other embodiments of the disclosure, the locking mechanism includes a clamping platform and a clamping groove, wherein the clamping platform is located on one of the base 100 and the upper housing 200, and the clamping groove is located on the other one of the base 100 and the upper housing 200. When the upper housing 200 is closed relative to the base 100, the clamping platform and the clamping groove are matched in a clamping manner to fix the upper housing 200 on the locking position being closed relative to the base 100. When the operator rotates the upper housing 200 hardly, the clamping platform and the clamping groove are separated so as to open the upper housing 200 relative to the base 100.

The printing mechanism 2 is configured to print a preset content on printing paper. The printing mechanism 2 includes a printing head 21 and a printing platen 22, wherein the printing platen 22 is provided on the base 100. The axis of the printing platen 22 extends along the width direction of the printing paper, and the printing platen 22 can rotate around the axis of itself. The printing head 21 is provided on the ribbon bracket 300. When the ribbon bracket 300 is closed relative to the base 100, the printing head 21 is tangent to the printing platen 22. When the ribbon bracket 300 is opened relative to the base 100, the printing head 21 and the printing platen 22 are separated.

Along the delivery direction of the printing paper, the paper roll supporting mechanism 1 is located at the upstream of the printing mechanism 2, provided on the base 100, and configured to accommodate and support a paper roll for printing. The paper roll supporting mechanism 1 may be a paper house or a paper roll supporting bracket. In the present embodiment, the paper roll supporting mechanism is a paper roll supporting bracket. When installing the printing paper, the locking hooks 520 and the locking shaft 530 are separated by rotating the wrench 521. Subsequently, the upper housing 200 is rotated to be opened relative to the base 100, and the paper roll supporting mechanism 1 is exposed, and the paper roll is installed on the paper roll supporting bracket. At the moment, since the ribbon bracket 300 is opened with the upper housing 200 relative to the base 100, the front end of the printing paper can be pulled out from the paper roll to pass the printing head 21 and the printing platen 22 so as to complete the installation of the paper roll.

The ribbon mechanism 3 is provided on the ribbon bracket 300, and includes a supply shaft 31 and a take-up shaft 32. When the ribbon bracket 300 is dosed relative to the base 100, the supply shaft 31 and the take-up shaft 32 are located at the other side of the printing head 21 relative to the printing platen 22, and both axis of the supply shaft 31 and the take-up shaft 32 are parallel to the axis of the printing platen 22 and the supply shaft 31 and the take-up shaft 32 may rotate freely around the axes of themselves, wherein the supply shaft 31 is configured to support the unused ribbon. The take-up shaft 32 is configured to support and rewind the used ribbon. When installing the ribbon, the locking hooks 520 and the locking shaft 530 are separated by rotating the wrench 521, then the upper housing 200 is rotated to be opened relative to the base 100, and at the moment, the ribbon bracket 300 is opened together with the upper housing relative to the base 100. Since the rotation angle of the ribbon bracket 300 is less than the rotation angle of the upper housing 200, an operating space for installing the ribbon is formed between the ribbon bracket 300 and the upper housing 200. The unused ribbon may be installed on the supply shaft 31, pulled out from the supply shaft 31, and then rewound on the take-up shaft 32 after passing between the printing head 21 and the printing platen 22.

After installation of the ribbon and the printing paper, the upper housing 200 is dosed relative to the base 100. The locking hooks 520 of the locking mechanism 500 are matched with the locking shaft 530 in a clamping manner. At this moment, the ribbon bracket 300 is closed relative to the base 100 together, and the printing head 21 is tangent to the printing platen 22 to wait for executing a printing operation. When the printer prints, the ribbon and the printing paper are located between the printing head 21 and the printing platen 22, wherein a coating surface of the ribbon is in contact with the printing paper and a non-coating surface of the ribbon is in contact with the printing head 21. A driving mechanism (not shown in the drawings) of the printer drives the printing platen 22 and the take-up shaft 32 to rotate, wherein the printing platen 22 delivers the printing paper downstream and the take-up shaft 32 rewinds the used ribbon. At the same time, a controller of the printer controls a heating element of the printing head 21 to heat as required to transfer the carbon powder on the coating of the ribbon onto the printing paper to generate a preset image and character.

The linkage mechanism 400 of the thermal transfer printer provided by the disclosure will be introduced in details below. The thermal transfer printer includes at least one group of linkage mechanisms 400. Preferably, the thermal transfer printer includes two groups of linkage mechanisms, and the two groups of linkage mechanisms 400 are provided symmetrically with respect to the center of width of the thermal transfer printer. One group of linkage mechanisms will be introduced as an example below.

The linkage mechanism 400 includes a driving member and a driven member, wherein the driving member is fixedly connected with the upper housing 200 and the driven member is fixedly connected with the ribbon bracket 300. The driving member and the driven member are engaged indirectly in a transmission manner through at least one transition member.

When the upper housing 200 rotates around the pivot shaft between the upper housing 200 and the base 100, the driving member is driven to rotate synchronously with the upper housing 200 to drive the driven member to rotate through engaging transmission, so that the ribbon bracket 300 fixedly connected with the driven member rotates around the pivot shaft between the ribbon bracket 300 and the base 100, wherein the rotation angle of the driving member is greater than that of the driven member. Therefore, through the linkage mechanism 400, when the upper housing 200 is driven to rotate, the ribbon bracket 300 may be driven to rotate therewith, and the rotation angle of the upper housing 200 is greater than the rotation angle of the ribbon bracket 300, i.e. when the upper housing 200 and the ribbon bracket 300 are opened relative to the base 100, an operating space for installing the ribbon is formed between the ribbon bracket 300 and the upper housing 200.

In the embodiment, the linkage mechanism includes a transition member, which is a first gear 41. The driving member is a second gear 42. The driven member is a third gear 43. The second gear 42 drives the third gear 43 through the first gear 41. The first gear 41 is a transmission gear capable of transmitting a movement. Wherein, the first gear 41 is pivoted with the base 100 through a first gear shaft 411 and may rotate around the first gear shaft 411. The second gear 42 is fixedly connected with the upper housing 200, sleeved with a second gear shaft 421 fixedly provided on the base 100, and capable of rotating around the second gear shaft 421 (i.e. the second gear shaft 421 functions as a pivot shaft of the upper housing 200 and the base 100 at the same time). At the same time, the second gear 42 is further engaged with the first gear 41. When the upper housing 200 rotates around the second gear shaft 421 and is opened or closed relative to the base 100, the second gear 42 rotates around the second gear shaft 421 together and drives the first gear 41 to rotate around the first gear shaft 411 at the same time. The third gear 43 is fixedly connected with the ribbon bracket 300, sleeved with a third gear shaft 431 fixedly provided on the base 100, and capable of rotating around the third gear shaft 431 (i.e. the third gear shaft 431 functions as a pivot shaft of the ribbon bracket 300 and the base 100 at the same time). At the same time, the third gear 43 is further engaged with the first gear 41.

When the first gear 41 rotates, the third gear 43 may be driven to rotate around the third gear shaft 431 so that the ribbon bracket 300 is rotated and opened or closed relative to the base 100. Wherein, the pitch diameter of the second gear 42 is less than that of the third gear 43, therefore, when the second gear 42 and the third gear 43 rotate the same number of teeth, the rotation angle of the second gear 42 is greater than that of the third gear 43, so that the rotation angle of the upper housing 200 is greater than that of the ribbon bracket 300. When the ribbon bracket 300 is rotated and opened with the upper housing 200 relative to the base 100, an operating space is formed between the ribbon bracket 300 and the upper housing 200 to install the ribbon.

Preferably, the second gear shaft 421 and the third gear shaft 431 are located at the same side of the first gear shaft 411 along a first direction. In a second direction vertical to the first direction, the second gear shaft 421, the first gear shaft 411 and the third gear shaft 431 are provided at intervals in turn (i.e. the pivot shaft of the upper housing and the pivot shaft of the ribbon bracket are located at the same side of the rotation axis of the transition gear in the first direction; in the second direction vertical to the first direction, the pivot shaft of the upper housing, the rotation axis of the transition gear and the pivot shaft of the ribbon bracket are provided at intervals in turn), wherein the first gear shaft 411 is closer to the bottom surface of the base than the second gear shaft 421 or the third gear shaft 431 in the first direction (preferably the height direction of the printer). Such structural arrangement satisfies design requirements of the appearance of the printer, and will not cause to destroy the neatness of the appearance of the printer.

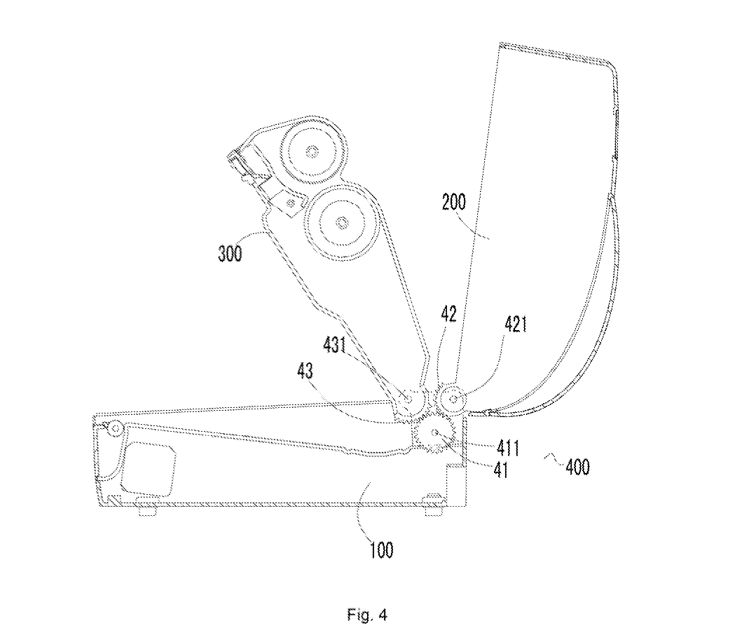

FIG. 4 is a structure side view of a thermal transfer printer when an upper housing is opened according to the first embodiment of the disclosure. The working principle of the linkage mechanism of the thermal transfer printer provided by the embodiment will be introduced below in combination with FIG. 2 and FIG. 4.

When the operator drives the upper housing 200 to open relative to the base 100, the second gear 42 fixedly connected with the upper housing 200 rotates around the second gear shaft 421 in the clockwise direction of the figures to drive the first gear 41 to rotate around the first gear shaft 411 in the counterclockwise direction of the figures, and the rotation of the first gear 41 drives the third gear 43 to rotate around the third gear shaft 431 in the clockwise direction of the figures. Since the ribbon bracket 300 is fixedly connected with the third gear 43, the carbon bracket 300 rotates around the third gear shaft 431 with the third gear 43 in the clockwise direction of the figures (i.e. rotating towards a direction away from the base 100). Thus, the ribbon bracket 300 is also rotated and opened relative to the base 100, wherein the rotation angle of the ribbon bracket 300 is less than that of the upper housing 200. When the upper housing 200 rotates with a preset angle, the upper housing 200 and the ribbon bracket 300 are stabilized at preset positions. At the preset position, the printing head 21 on the ribbon bracket 300 is separated with the printing platen 22 on the base 100, the opening angle of the ribbon bracket 300 relative to the base 100 is less than that of the upper housing 200 relative to the base 100, thus forming an operating space between the ribbon bracket 300 and the upper housing 200 to install the ribbon.

Preferably, when rotating with a preset angle, the upper housing 200 contacts with a limiting member (not shown in the figures) provided on the base 100. At this time, the maximum rotation angle of the upper housing, being open, is greater than 90°, i.e. the position of the gravity center of the upper housing 200 is located at the other side of the second gear shaft 421 relative to the gravity center of the base 100, thus the upper housing is stabilized at the opening position under the action of the gravity thereof. At the moment, the second gear 42 fixedly connected with the upper housing 200 is fixed and will not rotate. Therefore, the third gear 43 driven by the engagement of the first gear 41 and the second gear 42 are also fixed so that the ribbon bracket 300 fixedly connected with the third gear 43 is stabilized at the opening position.

When the operator drives the upper housing 200 to close relative to the base 100, the second gear 42 fixedly connected with the upper housing 200 rotates around the second gear shaft 421 in the counterclockwise direction of the figures, and the second gear 42 drives the third gear 43 through the first gear 41 to rotate around the third gear shaft 431 in the counterclockwise direction of the figures, so that the ribbon bracket 300 rotates in a direction close to the base 100. When the upper housing 200 is closed relative to the base 100, the printing head 21 on the ribbon bracket 300 is matched in a tangent manner with the printing platen 22 on the base 100.

With regard to the thermal transfer printer provided by the disclosure, the operator can drive the ribbon bracket to open with the upper housing relative to the base through opening the upper housing merely. In addition, the rotation angle of the ribbon bracket is less than that of the upper housing, thus forming an operating space therebetween for the operator to install or dismount the ribbon. Therefore, the ribbon or paper roll can be replaced conveniently through opening the upper housing merely, which is simple in operation and convenient in maintenance.

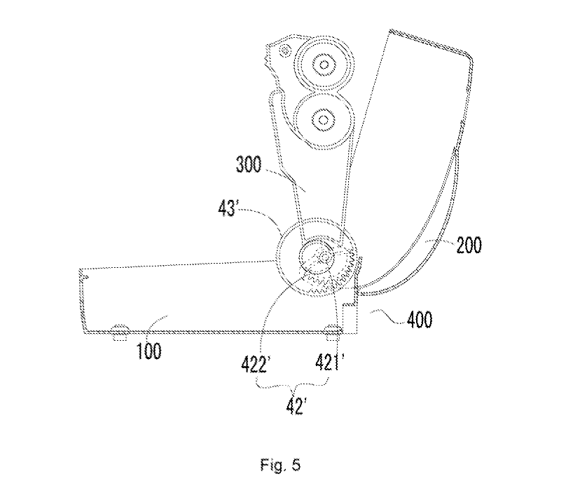

FIG. 5 is a structure side view of a thermal transfer printer when an upper housing is opened according to the second embodiment of the disclosure. As shown in FIG. 5, in the embodiment, the driving member of the linkage mechanism 400 is a fourth gear 42′, and the driven member is an annular gear 43′, wherein the base 100 is fixedly connected with an external sleeve 41′, the fourth gear 42′ and the annular gear 43′ are moveably connected with the external sleeve 41′, and the fourth gear 42′ is in engaging transmission with the annular gear 43′.

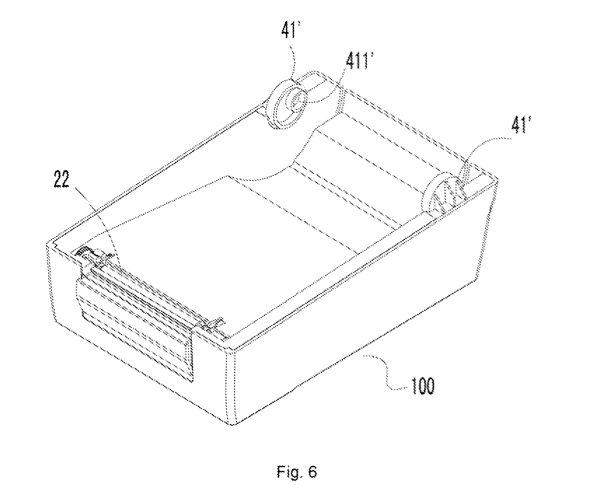

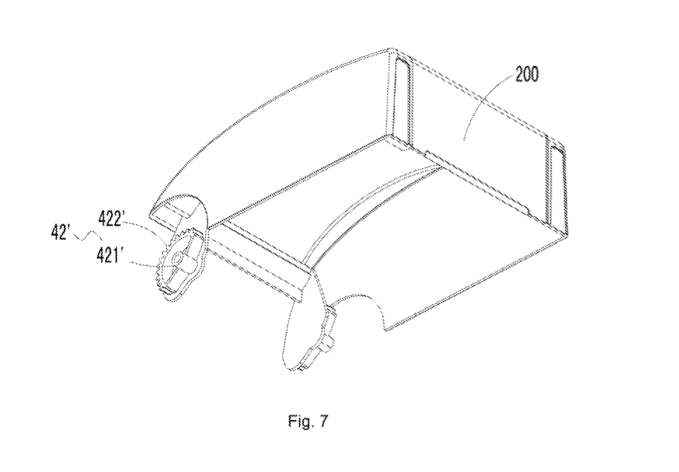

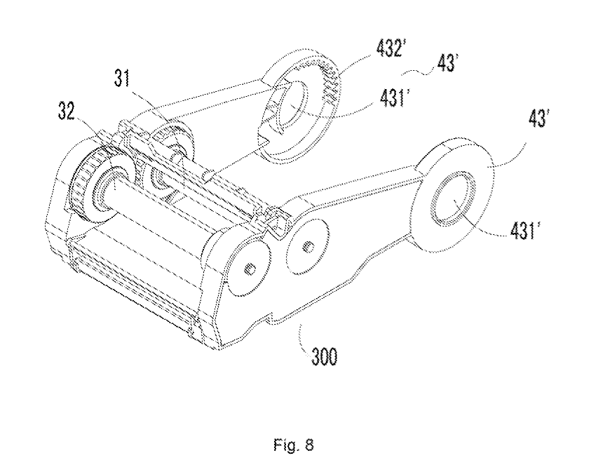

FIG. 6 is a structural view of a thermal transfer printer provided with a sleeve base according to the second embodiment of the disclosure, FIG. 7 is a structural view illustrating connection between a driving member of a linkage mechanism and an upper housing of a thermal transfer printer according to the second embodiment of the disclosure, and FIG. 8 is structural view illustrating connection between a driven member of a linkage mechanism and a ribbon bracket of a thermal transfer printer according to the second embodiment of the disclosure. As shown in FIG. 6 to FIG. 8, the external sleeve 41′ is fixedly connected with the base 100, and the internal sleeve 411′ is located inside the external sleeve 41′ and fixedly connected with the external sleeve 41′. The circle center of the internal sleeve 411′ and the circle center of the external sleeve 41′ are provided with a preset interval distance, i.e. set eccentrically.

The fourth gear 42′ is fixedly connected with the upper housing 200 and includes a rotation shaft 421′ and an external teeth part 422′, wherein the external teeth part 422′ is arranged in a fan shape taking the rotation shaft 421′ as the circle center. The central angle of the external teeth part 422′ is greater than or equal to the maximum opening angle of the upper housing 200 relative to the base 100. The external diameter of the rotation shaft 421′ is matched with the internal diameter of the internal sleeve 411′ of the external sleeve 41′. The rotation shaft 421′ protrudes from the external teeth part 422′, is matched with the internal sleeve 411′ of the external sleeve 41′ in a plugging manner, and is capable of rotating freely around the axis thereof. When the upper housing 200 is rotated and opened or closed relative to the base 100, the rotation shaft 421′ of the fourth gear 42′ fixedly connected with the upper housing 200 rotates relative to the internal sleeve 411′ of the external sleeve 41′ (i.e. the rotation shaft 421′ is the pivot shaft between the upper housing 200 and the base 100).

The annular gear 43′ is fixedly connected with the ribbon bracket 300 and includes a core hole 431′, and an internal teeth part 432′ provided in an annular taking the core hole 431′ as the circle center. The pitch diameter of the internal teeth part 432′ is greater than that of the external teeth part 422′ of the fourth gear 42′. The aperture of the core hole 431′ is matched with the external diameter of the external sleeve 41′. When the core hole 431′ of the internal teeth ring 43′ is sleeved with the external sleeve 41′, the annular gear 43′ may rotate relative to the external sleeve 41′ so as to drive the ribbon bracket 300 to rotate relative to the base 100 (i.e. the external sleeve 41′ is the pivot shaft between the ribbon bracket 300 and the base 100). At the same time, the internal teeth part 432′ on the annular gear 43′ is engaged with the external teeth part 422′ on the fourth gear 42′. During the rotation of the upper housing 200, the internal teeth part 432′ is always engaged with the external teeth part 422′.

The working principle of the linkage mechanism of the thermal transfer printer provided by the embodiment will be introduced below.

When the operator drives the upper housing 200 to open relative to the base 100, the upper housing 200 rotates around the rotation shaft 421′ in the clockwise direction of the figures to drive the fourth gear 42′ to rotate around the internal sleeve 411′ of the external sleeve 41′. The external teeth part 422′ of the fourth gear 42′ drives the internal teeth part 432′ of the annular gear 43′ to roll relative to the external teeth part 422′ so that the annular gear 43′ rotates around the periphery of the external sleeve 41′ in the clockwise direction of the figures, so as to drive the ribbon bracket 300 to rotate and open relative to the base 100 as well. Since the pitch diameter of the internal teeth part 432′ of the annular gear 43′ is greater than that of the external teeth part 422′ of the fourth gear 42′, the rotation angle of the annular gear 43′ is less than the rotation angle of the fourth gear 42′ in the case of rotating the same number of teeth.

Therefore, the rotation angle of the upper housing 200 is greater than the rotation angle of the carbon bracket 300, i.e. an operating space is formed between the upper housing 200 and the ribbon bracket 300 to install the ribbon.

In the thermal transfer printer provided by the embodiment, the upper housing and the ribbon bracket are pivoted with the base and both of them are driven by the engagement between the gears and the annular gear. When the upper housing is opened relative to the base, the fourth gear fixedly connected with the upper housing drives the annular gear fixedly connected with the ribbon bracket to rotate, so that the ribbon bracket is rotated and opened with the upper housing relative to the base. In the thermal transfer printer provided by the embodiment, since the upper housing and the ribbon bracket are driven by inner engaged gears, the printer is compactly structured to facilitate device miniaturization.

In other embodiments of the disclosure, the relation between the driving member and the driven member may be provided as follows: when the upper housing is within a preset angle opened initially, the driving member and the driven member are not engaged and the ribbon bracket keeps still. When the preset angle is exceeded, the driving member and the driven member are engaged so that the ribbon bracket is rotated and opened with the upper housing relative to the base. At the moment, the relation between the pitch circles of the driving member and the driven member is not limited to the pitch circle of the driving member being less than that of the driven member, and the rotation angle of the ribbon bracket which is fully opened may be also less than the rotation angle of the upper housing which is fully opened.

The above are only preferred embodiments of the disclosure and are not used for limiting the disclosure. For persons skilled in the art, the disclosure may have various alternations and changes. Any modifications, equivalent replacements, improvements and the like within the spirit and principle of the disclosure should be contained within the protection scope of the disclosure.

1. A thermal transfer printer comprising a frame, a printing mechanism (2), and a ribbon mechanism (3), wherein the frame comprises a base (100), and a ribbon bracket (300) and an upper housing (200) pivoted with the base (100) through a respective pivot shaft thereof, wherein the frame further comprises a linkage mechanism (400) used to open the ribbon bracket (300) in linkage when the upper housing (200) is opened relative to the base (100), wherein
the linkage mechanism (400) comprises a driving member fixedly connected with the upper housing (200) and a driven member fixedly connected with the ribbon bracket (300), wherein a rotation axis of the driving member is coaxial with a pivot shaft of the upper housing (200), and a rotation axis of the driven member is coaxial with a pivot shaft of the ribbon bracket (300); the driving member and the driven member are engaged directly or indirectly; a rotational direction of the driving member is the same with a rotational direction of the driven member; an operating space for installing the ribbon is formed between the upper housing (200) and the ribbon bracket (300) when the upper housing (200) is open.

2. The thermal transfer printer according to claim 1, wherein at least one transition member for transiting transmission is provided between the driving member and the driven member; the transition member is a gear; the driving member is a second gear (42); the driven member is a third gear (43).

3. The thermal transfer printer according to claim 1, wherein a rotation angle of the ribbon bracket (300) being open is less than a rotation angle of the upper housing (200) being open.

4. The thermal transfer printer according to claim 2, wherein the number of the transition member provided between the driving member and the driven member is one; the pivot shaft of the upper housing (200) and the pivot shaft of the ribbon bracket (300) are located at the same side of a rotation shaft of the transition member along a first direction; in a second direction vertical to the first direction, the pivot shaft of the ribbon bracket (300), the rotation shaft of the transition member and the pivot shaft of the upper housing (200) are provided at intervals in turn, wherein, in the first direction, the rotation shaft of the transition member is closer to a bottom surface of the base (100) than the pivot shaft of the upper housing (200).

5. The thermal transfer printer according to claim 2, wherein the driven member and the driving member are sector gears.

6. The thermal transfer printer according to claim 1, wherein the driving gear is a gear (42′); the driven gear is an annular gear (43′) directly engaged with the driving gear.

7. The thermal transfer printer according to claim 6, wherein an external sleeve (41′) as the pivot shaft of the ribbon bracket (300) is provided on the base (100); an internal sleeve (411′) is eccentrically provided inside the external sleeve (41′); the ribbon bracket (300) is provided with a core hole sleeved on the external sleeve (41′); the pivot shaft of the upper housing (200) is supported in the internal sleeve (411′).

8. The thermal transfer printer according to claim 1, further comprising a locking mechanism (500) for locking the upper housing (200) when the upper housing (200) is closed relative to the base (100).

9. The thermal transfer printer according to claim 8, wherein the locking mechanism (500) comprises:
a rotation shaft (510), provided on one of the upper housing (200) and the base (100);
a locking hook (520), fixedly connected to the rotation shaft (510);
a wrench (521), fixedly connected with an end of the rotation shaft (510) for driving the rotation shaft (510) to rotate; and
a locking shaft (530), located on another of the upper housing (200) and the base (100); when the upper housing (200) is closed relative to the base (100), the locking hook (520) is matched with the locking shaft (530) in a clamping manner.

10. The thermal transfer printer according to claim 1, wherein the maximum rotation angle of the upper housing (200) being open is greater than 90°.

11. The thermal transfer printer according to claim 1, wherein the printing mechanism (2) comprises a printing head (21) and a printing platen (22), wherein the printing head (21) is provided on the ribbon bracket (300); the printing platen (22) is provided on the base (100); the ribbon mechanism (3) comprises a supply shaft (31) and a take-up shaft (32); the supply shaft (31) and the take-up shaft (32) are provided on the ribbon bracket (300).
